(19) United States
(12) Patent Application Publication
(10) Pub. No.: US 2026/0336335 A1
(43) Pub. Date: Oct. 29, 2026

(54) SYSTEM AND METHOD FOR OIL MONITORING

(71) Applicant: Aperia Technologies, Inc., Hayward, CA (US)

(72) Inventors: Yi Luo, Hayward, CA (US); Jeff Root, Hayward, CA (US)

(73) Assignee: Aperia Technologies, Inc., Hayward, CA (US)

(21) Appl. No.: 19/662,444

(22) Filed: Apr. 29, 2026

Related U.S. Application Data
(60) Provisional application No. 63/796,729, filed on Apr. 29, 2025.
(60) Provisional application No. 63/867,497, filed on Aug. 20, 2025.

(51) Int. Cl. B60C 23/00; B60B 7/00; B60B 27/00

(52) U.S. Cl. CPC B60C 23/00318; B60B 7/0013; B60B 27/0068; B60B 2900/5112

(57) ABSTRACT

Aspects of the invention(s) described include a method and system for measuring or monitoring oil characteristics. A method can include: positioning a passive sensing element within an oil reservoir of a hub cap; positioning an inductive coil in proximity to the passive sensing element, wherein the inductive coil and passive sensing element cooperatively form an LRC circuit; generating a set of response signals upon exciting the LRC circuit with a reader; and with the reader, determining oil temperature, oil level, and/or other oil characteristics from the set of response signals. The invention(s) allow oil level, oil temperature, and other oil characteristics within an oil reservoir of a hub cap to be determined or estimated, even when an inflator is interfaced with the hub cap for inflating a tire of an associated wheel.

### CROSS-REFERENCE TO RELATED APPLICATIONS

This application claims the benefit of US Provisional Application number US 63/796,729 filed Apr. 29, 2025 and US Provisional Application number 63/867,497 filed Aug. 20, 2025, which are each incorporated in its entirety by this reference.

### TECHNICAL FIELD

This invention relates generally to the automotive field, and more specifically to a new and useful hub cap system for oil monitoring in the automotive field.

### BRIEF DESCRIPTION OF THE SEVERAL VIEWS OF THE DRAWINGS

FIG. 1 is a schematic representation of a variant of the system.

FIG. 2 is a schematic representation of a variant of the method.

FIG. 3 is a cross section of a variant of the hub cap.

FIG. 4 is an illustrative example of a variant of the system on a wheel.

FIG. 5 is an illustrative example of a variant of a set of transmission loss curves.

FIG. 6A and 6B are circuit diagrams depicting variants of the system.

FIG. 7 is an illustrative example of a variant of the set of capacitor electrodes and an inductor.

FIG. 8 is an exploded view of a variant of the hub cap.

FIG. 9 is an illustrative example of the reader system.

FIG. 10 is an illustrative example of a sensing element.

FIG. 11A and 11B are views of a variant of the circuit board.

FIG. 12 is an exploded view of a variant of the sensor assembly.

FIG. 13 is an illustrative example of a spacer.

FIG. 14 is an illustrative example of a variant of the system.

### DETAILED DESCRIPTION OF THE INVENTION

The following description of the embodiments of the invention is not intended to limit the invention to these embodiments, but rather to enable any person skilled in the art to make and use this invention.

### 1. Introduction

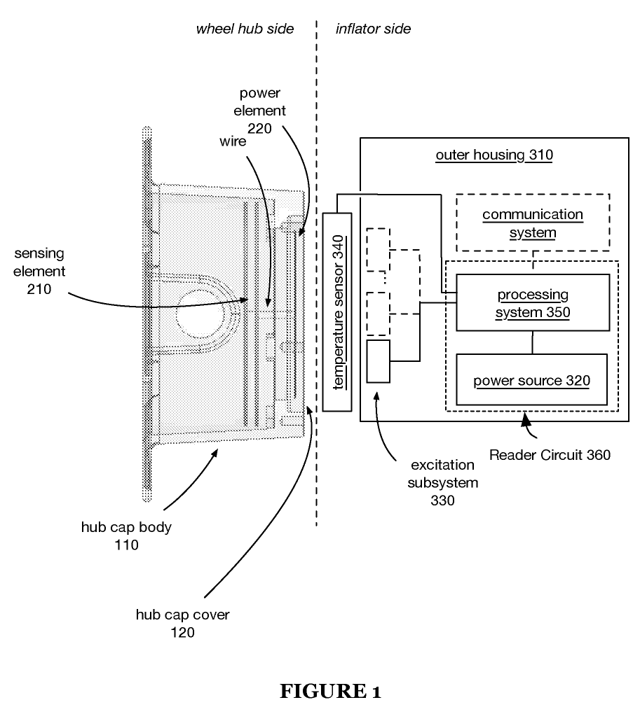

In variants, as shown in FIG. 1, a system can include a hub cap 100; a sensor assembly 200 including a sensing element 210 (e.g., set of capacitors), such as a passive sensing element 201 and a power element 220 (e.g., inductor); and a reader system 300 including an outer housing 310, a power source 320, an excitation subsystem 330 including a set of antennas 331; a temperature sensor 340, a processing system 350, and a reader circuit 360.

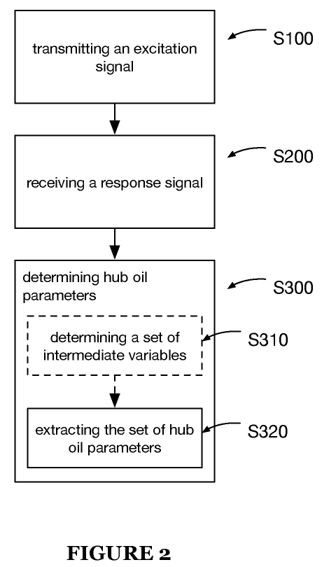

In variants, as shown in FIG. 2, a method can include: transmitting an excitation signal S100; receiving a response signal S200; and determining hub oil parameters S300 from the response signal, wherein S300 can further include determining a set of intermediate variables S310, and extracting the set of hub oil parameters S320 from the set of intermediate variables. In more detail, the method can include: positioning a passive sensing element within an oil reservoir of a hub cap; positioning an inductive coil in proximity to the passive sensing element, wherein the inductive coil and passive sensing element cooperatively form an LRC circuit; generating a set of response signals upon exciting the LRC circuit with a reader; and with the reader, determining an oil temperature and an oil level from the set of response signals.

In an illustrative example, (e.g., as shown in FIG. 1) variants of the system can include a hub cap cover with a sensor assembly arranged therein, and a reader system mountable to the hub cap exterior. The sensor assembly can include a passive LRC circuit formed from a pair of gap-separated parallel annular capacitor plates aligned along a central axis (e.g., a rotational axis of the wheel, etc.) and an inductor coil arranged around the central axis and electrically connected to the set of capacitor electrodes. The reader system can include: a set of antennas (e.g., an inductor coil inductively coupled to the hub inductor coil), a processing system, a power source, and an optional communication system. In examples, the reader system can be arranged within a wheel-end inflator configured to mount to the wheel end (e.g., over the hub cap cover). The LRC circuit can be positioned at least partially external to the oil reservoir, where the LRC circuit is in communication with the passive sensor assembly and configured to convert a signal from the passive sensor assembly to a resonant frequency. The reader in communication with the LRC circuit can include: an excitation subsystem configured to generate a set of response signals upon exciting the LRC circuit with a frequency sweep; and a processing system configured to convert the set of response signals to values of a set of oil characteristics (e.g., oil temperature, oil level, viscosity, debris accumulation, water content, etc.).

In operation, the reader system can emit an excitation signal (e.g., via the set of antennas) and measure the resultant resonant frequency of the LC circuit, wherein the oil level within the hub cap is determined based on the measured resonant frequency (e.g., based on the resonant frequency change from the resonant frequency of a known oil level). In variants, the system can also determine changes in oil condition by detecting changes in Q factors (e.g., determined by sweeping through a frequency band and analyzing the bandwidth of the resonant peak response); detecting phase shifts between the transmitted and received signals; and/or otherwise determine the oil condition.

### 2. Technical Advantages

Variants of the technology can confer one or more advantages over conventional technologies.

First, variants of the technology can enable automatic monitoring of oil level over time, without requiring a user to visually inspect oil level (e.g., through a window), as in conventional systems. Furthermore, for systems in which the hub cap is visually occluded (e.g., due to the presence of an inflator on a laterally outward side of the wheel, etc.), variants of the technology can enable oil level monitoring when a visual inspection is difficult. This automated approach can reduce maintenance downtime and improve operational efficiency by providing continuous monitoring capabilities without manual intervention. Relatedly, variants of the technology can enable automatic monitoring of other oil characteristics, including oil temperature, oil quality (e.g., in relation to debris or contaminants), oil viscosity, oil water content, oil degradation state, and/or other characteristics.

Second, variants of the technology can enable automatic oil monitoring for a rotating system (e.g., a wheel). Conventional oil monitoring sensing systems rely on a known orientation of sensor components (e.g., for oil monitoring within a rotationally stationary tank, etc.), making such systems difficult to integrate into a hub cap that rotates as a wheel associated with the hub cap rotates. Variants of the technology can utilize rotationally symmetric sensors that can provide consistent oil level measurements even as the rotational position of the hub cap changes. In a specific example, the radially-symmetric sensors can include annular capacitor electrodes mounted to the hub cap cover, which can maintain measurement accuracy regardless of wheel rotation angle.

Third, variants of the technology can improve the simplicity of hub cap construction by utilizing passive sensing components within the hub cap, such that batteries, active electronics, or electrical connections that may require complex sealing, maintenance, or replacement are supplied by external systems and not arranged within the hub cap. Such a passive approach can reduce manufacturing complexity, improve system reliability in harsh operating conditions, and minimize the risk of component failure that could contaminate the oil or interfere with wheel hub operations. For example, by eliminating the need for internal power sources and complex electronic assemblies, the hub cap design can be more robust and cost-effective to manufacture.

However, further advantages can be provided by the system and method disclosed herein.

### 3. System

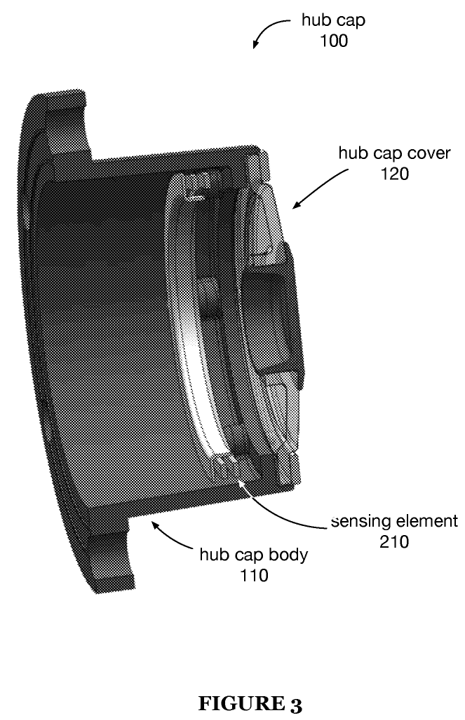

Embodiments of the system includes a hub cap 100; a sensor assembly 200; and a reader system 300, as shown in FIG. 1. The system functions to monitor hub oil parameters within a hub cap (e.g., example shown in FIG. 3).

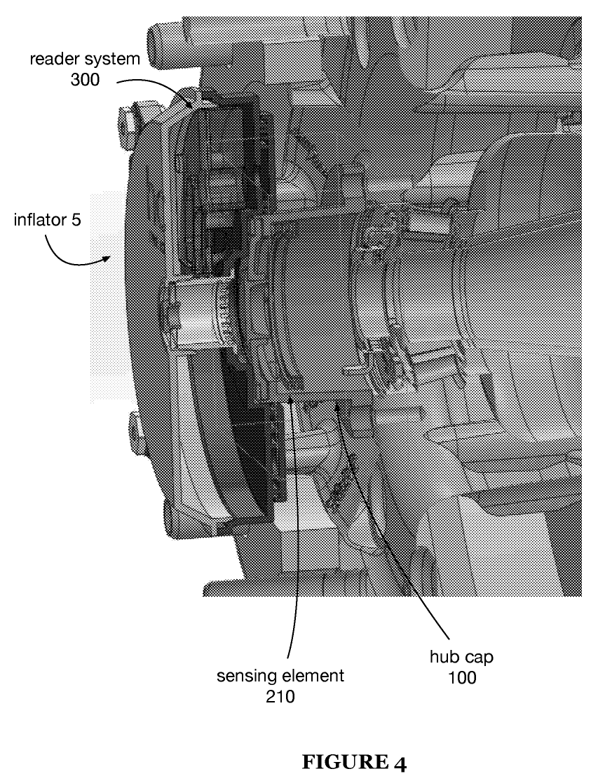

The system is preferably mounted to a hub cap 100 (e.g., example shown in FIG. 4) of a vehicle wheel, but can additionally and/or alternatively be mounted to another piece of rotating equipment. The wheel is preferably a wheel on a steering axle, but can alternatively be a wheel on a drive axle, and/or be any other wheel. The wheel can define a central axis (e.g., rotational axis of the wheel and/or hub cap, etc.), and/or define any other suitable axis or set of reference points.

The hub oil parameters that can be monitored by the system can include oil level (e.g., height of the oil surface within the hub cap, which can correspond to an oil volume, etc.), oil volume, oil quality and/or contamination (e.g., by debris), oil viscosity, water content, oil temperature, and/or any other suitable parameters. Hub oil parameters can additionally or alternatively be associated with temporal attributes (e.g., rate of change drainage rate, settling time, rate of oil degradation, etc.) of the aforementioned hub oil parameters.

The system preferably includes only passive elements within the hub cap (e.g., passive sensing elements positioned within the oil reservoir), but can additionally and/or alternatively include active elements.

The system can operate (e.g., can monitor oil parameters, etc.) while the vehicle is moving (e.g., above or below a threshold speed, etc.), while the vehicle is stopped, after the vehicle has been stopped for a threshold period of time (e.g., to enable the oil levels to settle), and/or at any other time.

The system can be used with or accommodate an inflator. The inflator can function to inflate the tire mounted to the wheel. In variants, the inflator can include: an inflator housing mountable to the wheel; a pump with a pump body statically mounted to the inflator housing and a piston actuatable relative to the pump body; a hanging mass freely rotatable relative to the inflator housing; and an asymmetric cam statically mounted to the hanging mass and engaging the piston, wherein relative motion between the housing and the hanging mass drives piston actuation relative to the pump body. In an example, the pump can define a big end with a symmetric or asymmetric bore, wherein the asymmetric cam can engage the pump's big end. The inflator housing and cam can be solid or define a bore therethrough. In variants where the inflator housing and cam define a bore therethrough, the bore can be coaxial with the rotational axis or offset from the rotational axis. The inflator can be shaped as an annulus, disc, and/or have any other shape. The inflator preferably mounts to the wheel, more preferably fits over the housing, but can alternatively mount to the housing, and/or be otherwise mounted.

In examples, the inflator can be any of the inflators disclosed in US Application No. 14/839,009 filed Aug. 28, 2015, US Application No. 18/538,645 filed Dec. 13, 2023, US Application No. 18/535,939 filed Dec. 11, 2023, each of which is incorporated herein by this reference in its entirety, and/or any other wheel-end inflator.

### 3.1 System – Hub Cap

The hub cap 100 functions to cap the wheel hub, and can define a reservoir (e.g., oil reservoir, lubricant reservoir, etc.). The hub cap 100 is preferably an oil bath hub cap, but can alternatively be a grease cap, and/or any other hub cap. All or parts of the hub cap are preferably non-metal (e.g., to prevent interference between a set of antennas and inductor of the oil level sensor system, etc.), but can alternatively be metal. In an example, the hub cap can include a metallized body with a plastic cover. The hub cap is preferably removably couplable to an existing wheel hub (e.g., via bolts, etc.), but can alternatively not be removably couplable.

The hub cap 100 is preferably composed of a polymeric material, but can additionally and/or alternatively be composed of a ceramic material, composite material, thermoplastic material, and/or any other suitable material.

The hub cap 100 can include or define a hub cap body 110 (i.e., housing) that extends axially from the wheel hub and defines the sidewalls of the oil reservoir, a fill area (e.g., a hole that extends from the sidewalls of the hub cap body into the oil reservoir) configured to receive oil, and/or a fill plug 130 (e.g., magnetic fill plug positioned within the oil reservoir and positioned to attract and collect metallic debris present in the oil). In embodiments with a magnetic fill plug, the magnetic fill plug can be positioned with clearance from the passive sensor assembly.

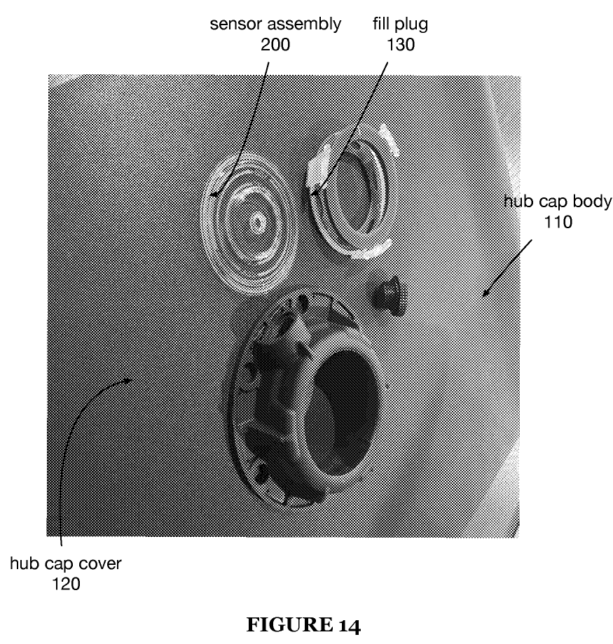

The hub cap 100 fill plug is preferably positioned with clearance from any sensors within the system such that it does not interfere with any signals, but can alternatively be positioned otherwise. The fill plug can include a hub cap cover 120 sealing against the distal end of the hub cap body (e.g., example shown in FIG. 14). Other portions of the hub cap 100 can additionally or alternatively include a cover sealing the reservoir against the distal end of the hub cap body, and/or any other components. The cover(s) can be opaque, include a window (e.g., into the oil reservoir, with concentric oil level indicators), and/or any other features.

### 3.2 System – Sensor Assembly

The sensor assembly 200 functions to monitor hub oil parameters within the hub cap. The sensor assembly 200 is preferably mounted within the hub cap, but can additionally or alternatively be mounted outside the hub cap, around the hub cap, and/or otherwise arranged relative to the hub cap. The sensor assembly can be mounted using a snap fit, threads, a ring, and/or any other coupling mechanism.

The sensor assembly 200 is preferably mounted close to the distal end of the hub cap (e.g., near the hub cap cover, to the hub cap cover, etc.), but can additionally or alternatively be mounted close to the proximal end of the hub cap cover, and/or to any other portion of the hub cap cover. In a first example, the sensor assembly 200 can be mounted to the sidewalls of the hub cap body. In a second example, the sensor assembly 200 can be mounted to the hub cap cover. The sensor assembly 200 can be snap fit into the hub cap cover (e.g., into a groove in the hub cap cover; between the hub cap cover and hub cap body), retained against the hub cap body by a retaining ring 202, constructed as a unitary component with the hub cap cover, screwed into the hub cap cover, magnetically attached to the hub cap cover, and/or otherwise attached to the hub cap cover. In a specific example, the sensor assembly can be mated to the hub cap cover via an annular snap fit. However, the sensor assembly can be otherwise mounted to the hub cap.

The sensor assembly is preferably a passive system (e.g., powered and/or excited by an external reader system), but can additionally or alternatively be an active system (e.g., include onboard power, controls, etc.), and/or be otherwise constructed.

The sensor assembly can measure oil level, oil quality (e.g., chemical composition, degradation, contaminants, debris, etc.), oil temperature, oil viscosity, water content, and/or any other parameter of the hub cap and/or contents therein (e.g., oil, lubricant, etc.).

The sensor assembly can measure the hub oil parameters based on resonance frequency characteristics, including or derived from one or more of: the peak resonance frequency, the resonant frequency shift, the measured capacitance, the measured resistance, the measured inductance, light intensity loss, light absorbance, wavelength shifts, refractive index, changes thereof (e.g., between the current measurement and a prior measurement or other reference value; decay over time; etc.), and/or any other signal feature. In an example, different hub oil parameters (e.g., oil level, temperature, quality, viscosity, etc.) can be determined based on how the measured RLC values (e.g., resonant responses) vary.

The sensor assembly 200 preferably includes a passive sensing element. Additionally, or alternatively, the sensor assembly 200 can include an active sensing element, semi-active sensing element, and/or any other suitable element.

The sensor assembly 200 can include a set of capacitors (e.g., parallel plates, interdigitated electrodes), an inductive sensor (e.g., coil, coil on a PCB, etc.), a LC circuit, a RC circuit, a RLC circuit, a set of floats, a set of resistors, a set of optical sensors, a set of thermistors, and/or any other set of sensors.

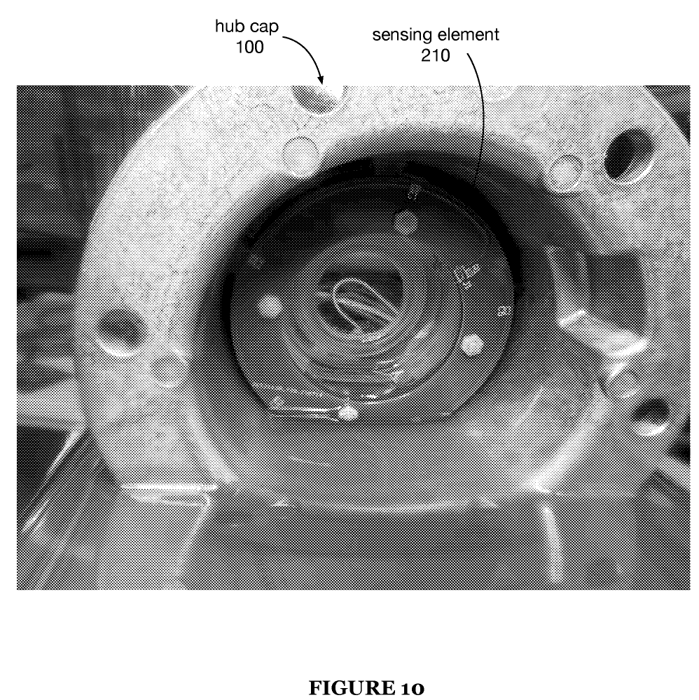

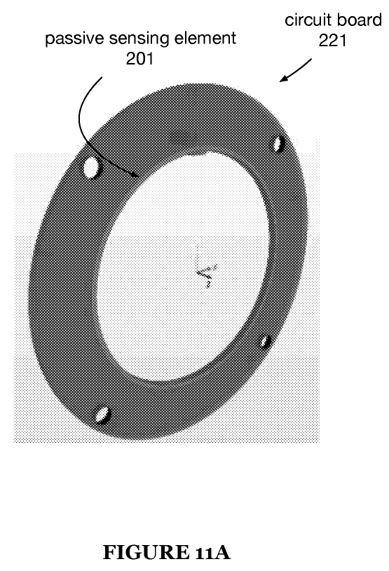

In a first variant, the sensor assembly 200 includes a set of parallel plate capacitor electrodes aligned with a rotational axis of the wheel (e.g., a central axis of the system, etc.); and an inductor (e.g., coil) electrically connected to the set of parallel plate capacitors. The parallel plate conductors are preferably annular (e.g., washer-shaped), but can alternatively be solid discs and/or have any other suitable construction. In a first specific example, the sensor assembly 200 can include two annular disc parallel plate capacitor electrodes coaxially aligned with the hub cap and electrically connected to an inductive coil, where the inductive coil is structured to change inductance depending on oil level. In a second specific example, the sensor assembly 200 can additionally include a set of temperature-sensitive capacitors (e.g., annular discs) electrically connected to a second inductive coil (e.g., electrically isolated from or coupled to the first inductive coil). The temperature-sensitive capacitors can be the parallel plate capacitor electrodes in the first example (e.g., be excited at a different frequency, using a different pattern, etc. to measure temperature), or be separate and distinct capacitors from the parallel plate capacitors in the first specific example (e.g., be a set of coils mounted on a PCB, example shown in FIG. 10). The temperature-sensitive capacitors can have the same or different configuration as the parallel plate capacitors in the first specific example.

In a second variant, the sensor assembly 200 includes a set of concentric cylindrical parallel plate capacitor electrodes extending from an interior surface of the hub cap cover and aligned with a central axis of the system; and an inductor electrically connected to the set of parallel plate capacitors.

In a third variant, the sensor assembly 200 can include a magnetic float and a set of magnetic contacts at different heights or radial distances within the oil hub. In an example of the third variant, the sensor assembly can measure the oil level based on which magnetic contact the magnetic float is coupled to.

In a fourth variant, the sensor assembly can include an ultrasonic level sensor.

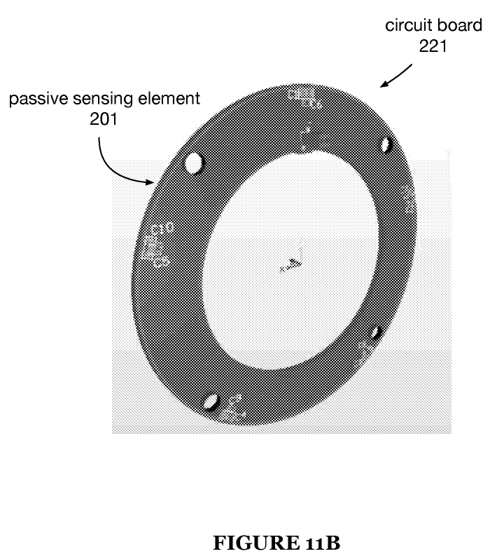

In a fifth variant, the sensor assembly 200 can include a silicon temperature sensor configured to provide baseline calibration and correct for drift in temperature measurements (e.g., examples shown in FIGS. 11A and 11B).

In a specific example, the inductor and set of capacitor electrodes are built into a sensor assembly which mates with the hub cap cover via a connection interface (e.g., snap fit, threads, and/or any other connection mechanism) on a sensor assembly support (e.g., a plastic flanged ring, and/or any other support structure).

However, the sensor assembly can be otherwise configured.

The sensing element functions to measure a physical property of the oil within the hub cap, wherein the physical property can be indicative of a parameter of the oil (e.g., oil level, oil quality, oil temperature, oil degradation, water content, and/or any other suitable oil parameter). The sensing element is preferably arranged within the hub cap, but can alternatively be arranged elsewhere. In a first variant, the sensing element can be assembled into the hub cap (e.g., snap-fit, bolted, glued, attached using a threaded collar, etc.). In an example of the first variant, the sensing element can be mated to the interior of the hub cap body or hub cap cover before assembly onto the wheel hub. In a second variant, the sensing element can be manufactured as an integrated unit with the hub cap. As such, the sensing element 210 can be arranged within the hub cap and/or any other location.

The sensing element 210 can include a single sensing element, a pair of sensing elements, and/or any other suitable number of sensing elements (e.g., each for measuring a different physical property of the oil, etc.). Each sensing element can measure one or more attributes of the oil. In a first example, a single sensing element measures a single physical property of the oil (e.g., oil level). In a second example, a first sensing element can measure a first property of the oil (e.g., oil level via resonant frequency), and a second sensing element can measure a second property of the oil (e.g., a temperature of the oil). In a third example, a single sensing element 210 can measure multiple properties of the oil (e.g., oil level and oil temperature). In the third example, the single sensing element 210 can comprise a surface-mount ceramic capacitor (e.g., X5R, X7T) that changes capacitance with temperature, thereby providing signals from which oil level and oil temperature can be determined.

The sensing element 210 is preferably rotationally symmetric about the central axis, but can alternatively not be rotationally symmetric. In variants, the rotational symmetry about the central axis can enable the system to determine the oil level (and/or other oil parameters) regardless of the wheel's angular position. The sensing element preferably defines an annulus and is rotationally symmetric about the central axis, but can alternatively define an arcuate segment, a disc, and/or have any other configuration. The inner diameter of the sensing element is preferably larger than a wheel spindle diameter (e.g., such that the spindle can extend into the longitudinal annular cavity defined by the capacitor electrodes, and such that the capacitor electrodes can spin about the spindle without contacting the spindle, etc.) but the inner diameter can alternatively have any other suitable dimension.

The sensing element 210 is preferably a passive sensing element, but can additionally and/or alternatively be an active sensing element (e.g., electrically connected to the power element, etc.). The sensing element is preferably electrically connected to the power element, and/or any other components.

The sensing element 210 can include a coating (e.g., conformal coating) to prevent degradation from oil or aging. Additionally or alternatively, the sensing element can include a protective sleeve, housing, sealant, and/or any other suitable barrier.

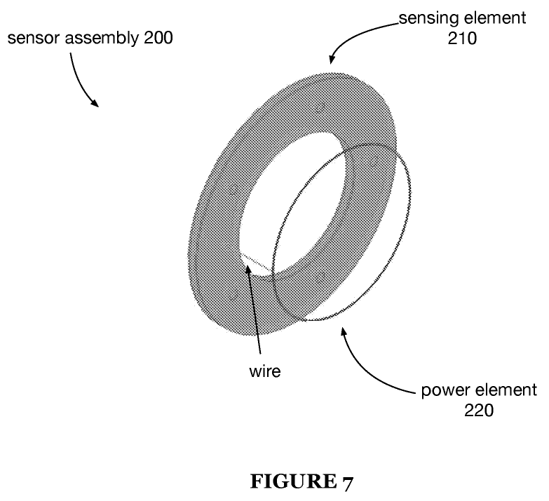

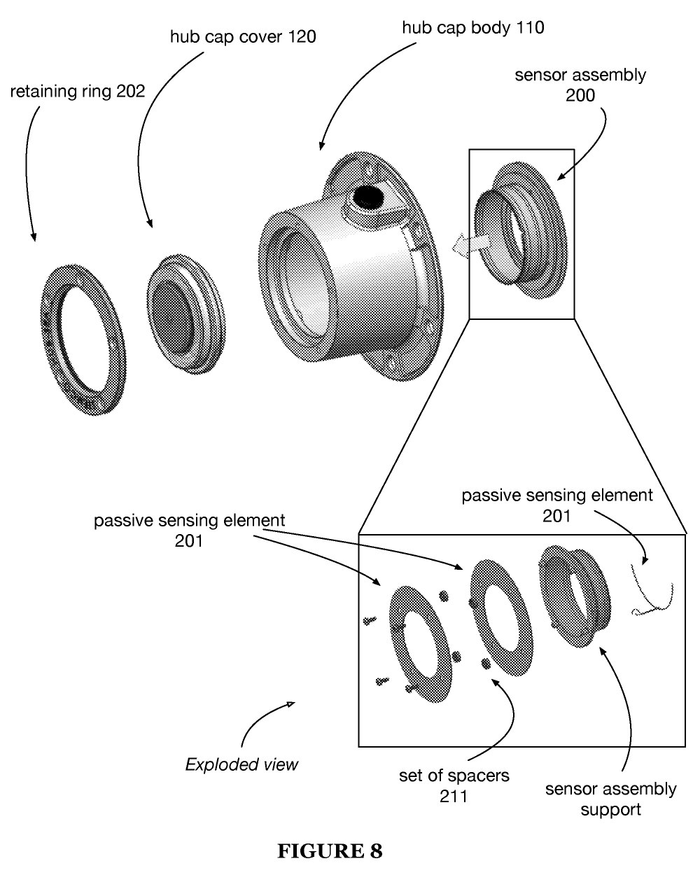

In a variant, the sensing element 210 can include a set of capacitor electrodes (e.g., electrodes configured as plates). The set of capacitor electrodes are preferably annular (e.g., example shown in FIG. 7), but can alternatively be solid disks or another suitable shape. The set of capacitor electrodes are preferably arranged perpendicular to the central axis of the axle (e.g., concentrically arranged relative to the axle axis), but can alternatively be arranged non-perpendicular to the central axis of the axle. The set of capacitor electrodes preferably cooperatively form a parallel plate capacitor, but can alternatively form a cylindrical capacitor or a capacitor with any other suitable geometry.

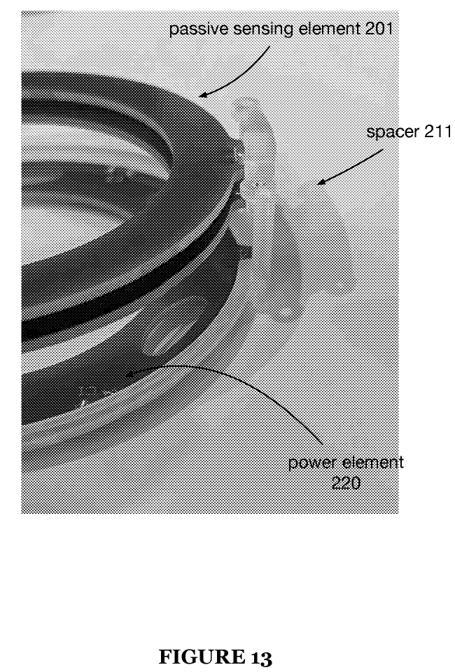

The parallel plate capacitor is preferably electrically isolated from the wheel hub, hub cap (e.g., the interior wall of the hub cap), spindle, other capacitive plates, power element, and/or any other components. The capacitive plates can be electrically isolated by a gap between the capacitor electrodes. The gap between the capacitor electrodes can include a gap between the capacitor electrodes and the interior wall of the hub cap and/or a set of spacers 211. In a first example, the spacers can help maintain substantially parallel spacing between the capacitive plates. In a second example, the spacers can help maintain a certain amount of space between the capacitive plates and the power element (e.g., example shown in FIG. 13). Furthermore, the capacitive sensing elements/capacitive plates can be positioned with clearance from an interior wall of the hub cap configured to prevent electrical shorting from conductive debris within the oil reservoir.

The set of spacers including spacer 211 are preferably non-conductive and/or non-metallic, but can alternatively be made of any other suitable material.

In an example, a spacing between adjacent capacitor electrodes can be 1mm, 3mm, 5mm, 10mm, 15mm, 20mm, a spacing within an open or closed range bounded by the aforementioned values, and/or any other suitable spacing. The spacing is preferably uniform across the gap between capacitor electrodes but can alternatively be non-uniform.

The set of capacitor electrodes/plates of the sensing element 210 can be made of copper, but can additionally or alternatively be made of aluminum, steel, and/or any other materials. The capacitors can preferably be Class II ceramic capacitors (e.g., X5R, X7R, etc.) that provide signals indicative of oil level changes and/or oil temperature changes. Additionally or alternatively, the capacitors can be any other suitable type of capacitor.

The dielectric layer disposed between the pair of capacitive plates can include a temperature sensitive material (i.e., the capacitance of the plates can change with temperature). Alternatively, the dielectric layer disposed between the pair of capacitive plates can include a temperature insensitive material and/or any other suitable material.

In a first embodiment, the set of capacitor electrodes form a parallel plate capacitor, wherein each capacitor can be planar (e.g., an annulus, a disc, a non-circular or curvilinear shape, etc.).

In a second embodiment, the set of capacitor electrodes form a cylindrical capacitor, wherein the capacitor electrodes can have different radii and be concentrically nested within one another (e.g., as a cylindrical capacitor assembly). In a variant of the second embodiment, the set of capacitor electrodes can form a nested prismatic configuration (e.g. non-cylindrical in morphology).

The sensor assembly 200 can include two capacitor electrodes and/or three capacitor electrodes. In a first example, the set of capacitor electrodes can include a first electrode and a second electrode parallel to one another. In a second example, the set of capacitor electrodes can include a middle electrode and a pair of outer electrodes (e.g., on either side of the middle electrode), wherein the central axis passes through all three electrodes. The three capacitor electrodes can include 4+ electrodes and/or any other number of capacitor electrodes.

The capacitor electrodes can be offset from the hub cap body by a radial gap, mounted directly to the hub cap body, and/or otherwise arranged relative to the hub cap body. The radial gap is preferably constant, but can alternatively vary depending on the radial angle around the capacitor electrode.

However, the sensing element can alternatively be an ultrasonic sensor (e.g., emitting high-frequency sound waves towards the oil surface and measuring the time for sound to travel back up), a magnetic float system including a magnetic float and a set of contact couplings at different heights within the hub cap and/or any other suitable type of sensing element.

However, the sensing element may be otherwise configured.

### 3.3 System – Power Element

The power element functions to power the sensing element and/or excite the sensing element. The power element is preferably electrically connected to the sensing element (e.g., via wires extending axially along the interior hub cap wall, etc.), but can alternatively be part of the sensing element or otherwise connected to the sensing element. In an example, an LC resonant circuit can be formed with the capacitor electrodes of the sensing element. The power element is preferably arranged inside the hub cap, but can alternatively be arranged within a cavity defined by the wheel hub, arranged outside the hub cap, and/or in any other location. The power element can be mounted to the hub cap cover, to the hub cap body, and/or to any other component of the hub cap. The power element 220 can include a conformal coating (e.g., conformal coating) in order to prevent degradation from oil or aging. Additionally or alternatively, the power element 220 can include a protective sleeve, housing, sealant, and/or any other suitable barrier. The power element is preferably static relative to the hub cap and/or wheel hub, but can alternatively be not static relative to the hub cap and/or wheel hub. The power element is preferably conductively electrically isolated from components outside of the wheel hub (e.g., components within the outer housing such as the power source, processing system, etc.), but can alternatively be conductively electrically connected to components outside of the wheel hub. The power element is preferably passive, but can alternatively be active. The power element is preferably an inductor (e.g., induction coil, etc.), but can alternatively be a battery, an antenna, a connection to an exterior power source (e.g., a power source of the reader system, etc.), and/or any other power source. The power element is preferably inductively coupled with a reader system (e.g., the set of antennas within the reader system), but can alternatively not be inductively coupled.

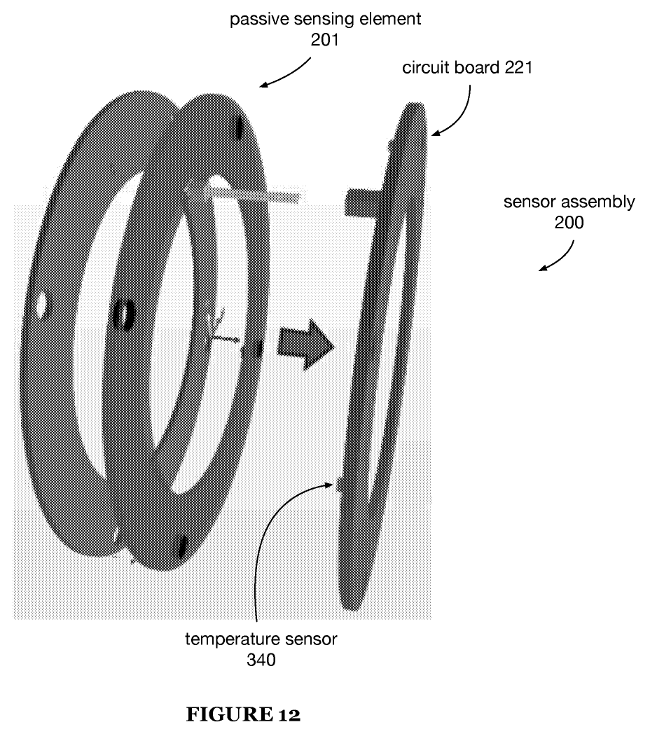

The power element 220 can be defined on a circuit board 221, but can alternatively be defined on any other suitable form. The circuit board can connect to the sensing element (e.g., one capacitive plate, both capacitive plates, etc.) via an electrical connection (e.g., PCB ribbon). The electrical connection can function to eliminate some connections and losses associated with the system and/or have any other suitable function (e.g., example shown in FIG. 12).

The power element 220 is preferably an inductor (e.g., induction coil, etc.), but can alternatively be a battery, an antenna, a connection to an exterior power source (e.g., a power source of the reader system, etc.), and/or any other power source. The power element 200 is preferably inductively coupled with the reader system (e.g., the set of antennas within the reader system described in further detail below), but can alternatively not be inductively coupled.

In a variant, the power element includes an inductor coil. The inductor coil can have 1 turn, 2 or more turns (e.g., 10 turns to increase inductance in the limited hub cap cavity), and/or any other number of turns. The inductor can be a planar coil, a helical coil, and/or any other suitable type of coil. The inductor coil can include one or more coils. The coils can be symmetrical about a central rotational axis, but can alternatively be offset from the central axis. The central rotational axis can be the central axis of the wheel, wheel hub, hub cap, the capacitive electrodes, or a different axis. In variants, the power element can include an inductor coil integrated with a printed circuit board (PCB) mounted to the hub cap cover.

However, the power element may be otherwise configured.

Furthermore, the sensor assembly may be otherwise configured.

### 3.4 System – Reader System

The reader system 300 functions to read signals off the sensor assembly. The reader system 300 can additionally or alternatively power the sensor assembly, excite the sensor assembly, and/or otherwise interact with the sensor assembly. The reader system 300 is preferably separate from the sensor assembly, but can additionally or alternatively be part of the sensor assembly. The reader system 300 is preferably separate from the hub cap (e.g., a standalone module), but can alternatively be integrated into the hub cap (e.g., to the exterior of the hub cap, interior of the hub cap, etc.) and/or have any other suitable arrangement. In a first example, the reader system 300 can be implemented into an attachment used with a cellphone (e.g., phone dongle). In a second example, the reader system 300 can be a separate puck which can attach to the hub cap (e.g., for retrofitting onto older units, etc.).

The reader system 300 can be removably coupled with the hub cap (e.g., via magnetic attachments, threaded fasteners, quick-release connectors, and/or any other suitable connectors). The reader can be integrated into a housing of the hub cab. The reader can additionally or alternatively include a standalone module that is removably coupled with the hub cap. Alternatively, the reader system 300 can be permanently coupled with the hub cap and/or have any other suitable coupling.

The reader system 300 can be integrated into the inflator 5, a secondary housing, a phone, a dongle, a handheld reader, be integrated into the hubcap, be a separate component, and/or be otherwise arranged. In variants where the reader system is integrated into the inflator, the reader system can be arranged along the back of the inflator (e.g., along the face proximal the hub cap), located along an outer surface of the inflator (e.g., within a groove defined in the inflator) or arranged within the inflator, and/or otherwise arranged. The reader system can be integrated into the inflator, a secondary housing, a phone, a dongle, a handheld reader, be integrated into the hubcap, be a separate component, and/or be otherwise arranged. In variants where the reader system is integrated into the inflator, the reader system can be arranged along the back of the inflator (e.g., along the face proximal the hub cap), located along an outer surface of the inflator (e.g., within a groove defined in the inflator) or arranged within the inflator, and/or otherwise arranged.

In variants, the reader system 300 includes an optional outer housing 310; a power source 320; an excitation subsystem 330 with a set of antennas 331; an optional temperature sensor 340; a processing system 350; and a reader circuit 360.

### 3.4.1 System – Reader System Housing

The outer housing 310 can optionally function to protect and retain the reader system components are outside of the hub cap. The outer housing 310 preferably encapsulates the power source, set of antennas, temperature sensor, processing system, and/or any other suitable components. The outer housing 310 is preferably plastic (e.g., to minimize RF attenuation), but can alternatively be metal or another suitable material. The outer housing 310 can be the housing of the inflator or can be a separate component.

However, the outer housing 310 may be otherwise configured.

### 3.4.2 System – Reader System Power

The power source 320 functions to provide power to the processing system, antenna, temperature sensor, power element, and/or other system components. The power source 320 can be a battery, a power generator (e.g., that generates power from relative motion between a hanging element and the wheel, etc.), or alternatively a power source of another suitable type. In a variant in which an inflator is mounted to the hub cap, the power source 320 is preferably the same power source as used for the inflator (e.g., for sensors of the inflator), but can alternatively be a different power source. The power source 320 preferably operates at low power (e.g., between 0 and 10 dBm). Additionally or alternatively, the power source 320 can operate at high power (e.g., above 10 dBm) and/or any other suitable power level.

However, the power source 320 may be otherwise configured.

### 3.4.3 System – Reader System Excitation/Antennas

The excitation system 330 functions to excite the sensor assembly (e.g., the LC circuit formed by the sensing element and power element) with an excitation signal, and receive a response signal from the sensor assembly. The excitation system 330 preferably includes a set of antennas and/or other excitation elements. The set of antennas 331 functions as a transceiver (e.g., transmit excitation signals to the inductor and/or receive a response signal back, etc.), as a receiver, as a transmitter, and/or any other suitable configuration.

The set of antennas 331 can thus include a first antenna configured to excite the LRC circuit. The set of antennas 331 can include a second antenna configured to receive the set of response signals.

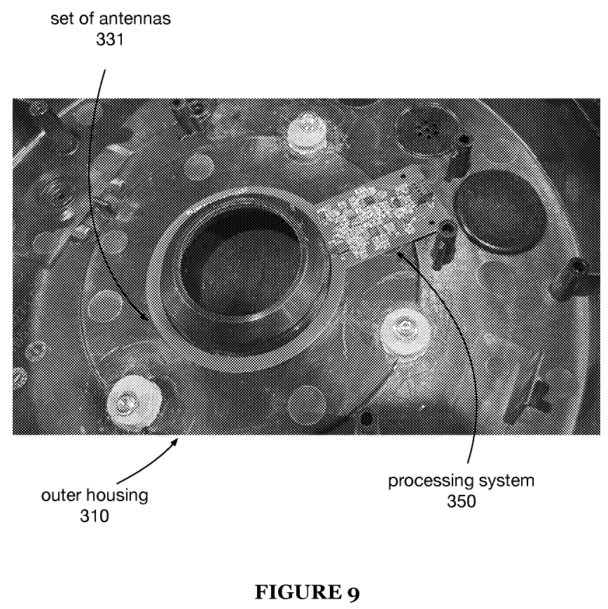

The set of antennas 331 is preferably arranged within the outer housing, but can alternatively be arranged outside the outer housing (e.g., between the outer housing and the hub cap, etc.). The set of antennas 331 is preferably centered about the central axis of the system, but can alternatively be offset from the central axis. In variants, the system can include a single antenna (e.g., in which the antenna both transmits and receives RF signals as in S100 and S200) or multiple antennas (e.g., in which different antennas are transmit-only or receive-only). In a variant, the set of antennas 331 can be a ring-shaped antenna with a central axis coaxially aligned with the wheel axis of rotation (e.g., example shown in FIG. 9). However, the antennas can be otherwise shaped.

The set of antennas 331 is preferably arranged proximal to the power element of the sensor assembly (e.g., at a wall of the outer housing which interfaces with the hub cap), but can alternatively not be arranged proximal to the power element. The distance between the set of antennas 331 and the power element of the sensor assembly (e.g., in a direction parallel with the central axis, etc.) can be 2mm, 3mm, 4mm, 5mm, 8mm, 10mm, 15mm, 20mm, 30mm, a distance within an open or closed range bounded by the aforementioned values, and/or be any other suitable distance.

In examples, the set of antennas 331 can include an inductor coil, wherein the antenna parameters can be substantially similar to the parameters of the sensor assembly's inductor coil. In an example, the set of antennas 331 can include a set of antennas, wherein the antennas have substantially the same diameter as the power element of the sensor assembly and are wound around a central axis of the inflator (e.g., wherein the central axis of the inflator is configured to align with the rotational axis of the wheel).

The set of antennas 331 is preferably electrically connected to the processing system and/or power source, but can alternatively not be electrically connected. The set of antennas 331 is preferably electrically isolated from the sensor assembly, but can alternatively be electrically coupled, and/or otherwise electrically connected.

In a first example, the set of antennas 331 can be defined within a PCB (e.g., as a PCB antenna, as a set of PCB traces, etc.), wherein the PCB can be mounted to the inflator housing (e.g., to the interior of the inflator housing back wall). As such, one or more antennas of the set of antennas 331 can be defined within a reader-side PCB (e.g., as a PCB antenna, as a set of PCB traces, etc.), wherein the PCB can be mounted to the inflator housing (e.g., to the interior of the inflator housing back wall). In a specific example, the PCB can surround the central axis and include a bore passing through the PCB along the central axis.

In a second example, one or more of the set of antennas 331 can be an over-molded coil. In this example, the set of antennas 331 can be integrated with the housing (e.g., wherein the housing is molded over the coil) or the over molded antenna can be arranged between the housing and the hub cap (e.g., such that the antenna is electrically isolated from the housing and/or the hub cap).

### 3.4.4 System – Reader System Temperature Sensing

The temperature sensor 340 functions to determine temperature of the oil within the hub cap. The temperature sensor 340 is preferably arranged on the outside of the hub cap, but can alternatively be arranged inside the hub cap.

The temperature sensor 340 is preferably arranged outside the outer housing of the reader, but can alternatively be arranged within the outer housing. In a first variant, in which the temperature sensor is outside the hub cap, the temperature sensor is preferably arranged outside the outer housing of the reader, but can alternatively be arranged within the outer housing. In the first variant, the temperature sensor is preferably arranged between the outer housing and the hub cap (e.g., flat against a distal surface of the hub cap or outer portion of the hub cap cover), but can additionally or alternatively be otherwise arranged. The temperature sensor is preferably communicatively connected to the processing system, but can alternatively not be communicatively connected to the processing system.

In a second variant, in which the temperature sensor is inside the hub cap, the temperature sensor is preferably mounted to the hub cap cover (e.g., alongside the power element, etc.) but can alternatively be mounted at any other suitable location. In variants where the temperature sensor is passive and inside the hub cap, the temperature sensor can be inductively coupled to the reader system, enabling wireless temperature measurement while the vehicle is in motion and/or stationary. In this variant, the temperature sensor can be mounted directly to a PCB housing the power element (e.g., the temperature sensor can be a surface-mount (SMD) component on the PCB) and/or can be mounted to any other suitable system component. In variants in which the temperature sensor is mounted to a PCB, the temperature sensor inductor coil can be arranged on an opposite side of the PCB from the oil sensor inductor coil, on the same side, or on an intermediate layer. The temperature sensor is preferably electrically coupled to a temperature sensor inductor coil integrated with the PCB (e.g., forming a trace specific to the temperature sensor) but can alternatively be electrically coupled to an inductor coil of any other suitable type. The trace can form a single-turn inductor coil, a multi-turn inductor coil, and/or can have any suitable inductor configuration. The temperature sensor and its associated inductor coil can form a second LC resonant circuit that operates at a different resonant frequency than the oil level sensing LC circuit (e.g., 25 MHz for temperature vs. 50 MHz for oil level, etc.). In a specific example, the temperature sensor can be a second sensing element within the hub cap (e.g., a set of temperature-sensitive capacitors, etc.). In a specific example, the temperature sensor can be the temperature-sensitive capacitors. (e.g., via a wired connection, an inductive coupling, etc.). The temperature data can be used for temperature compensation of oil level measurements, oil quality assessment through viscosity monitoring, bearing health monitoring, and/or contamination detection.

The temperature sensor 340 can be active or passive.

The temperature sensor 340 is preferably arranged between the outer housing and the hub cap (e.g., flat against a distal surface of the hub cap or outer portion of the hub cap cover), but can additionally or alternatively be otherwise arranged. The temperature sensor 340 is preferably communicatively connected to the processing system, but can alternatively not be communicatively connected to the processing system.

In specific examples, the temperature sensor 340 can be a second sensing element within the hub cap (e.g., a set of temperature-sensitive capacitors, etc.), or can be the same capacitors of the sensor assembly 200. As such, the temperature-sensitive capacitors can be the parallel plate capacitor electrodes (e.g., be excited at a different frequency, using a different pattern, etc. to measure temperature), or be separate and distinct capacitors from the parallel plate capacitors (e.g., be a set of coils mounted on a PCB, example shown in FIG. 10). The temperature-sensitive capacitors can have the same or different configuration as the parallel plate capacitors in the first specific example.

Examples of a single sensing element can comprise a surface-mount ceramic capacitor (e.g., X5R, X7T) that changes capacitance with temperature, thereby providing signals from which oil level and oil temperature can be determined.

However, the temperature sensor 340 may be otherwise configured.

### 3.4.5 System – Reader System Processor

The processing system 350 functions to determine hub oil parameters from sensor measurements. The processing system can be arranged: within the inflator, within the reader system, remote from the inflator, remote from the hub cap cover, remote from the outer housing, and/or be otherwise arranged. The processing system can be a different processing system from the inflator processing system, but can alternatively be the same processing system. The processing system preferably performs all or portions of the method (e.g., S100, S200, and/or S300), but can additionally or alternatively perform other suitable processes.

The processing system 350 can include architecture (e.g., instructions stored on non-transitory media, that, when executed, perform functions described). As such, the processing system 350 can perform an algorithm in order to determine oil parameters from sensor measurements (e.g., using a MUSIC-derived algorithm, using an ESPRIT-derived algorithm, etc.).

The processing system is preferably communicatively connected to the set of antennas, temperature sensor, a communication system, and/or any other components. In an example, the processing system can be connected to the antenna, temperature sensor, set of antennas, power source, and/or any other suitable components via a reader system circuit.

However, the processing system 350 may be otherwise configured.

### 3.4.6 System – Reader System Circuit

The reader circuit 360 functions to excite the sensor assembly, measure the resonant response, and/or perform other functionality.

The circuit components of the reader circuit 360 are preferably electrically connected to (e.g., by wires, traces, etc.) the set of antennas, preferably inductively connected to the sensor assembly (e.g., to the RC circuit, etc.), but can additionally or alternatively be otherwise connected to the sensor assembly, and/or can optionally include and/or interface with an analog-to-digital converter (ADC) that converts an analog response signal received from the set of antennas into digital data that the processing system can process.

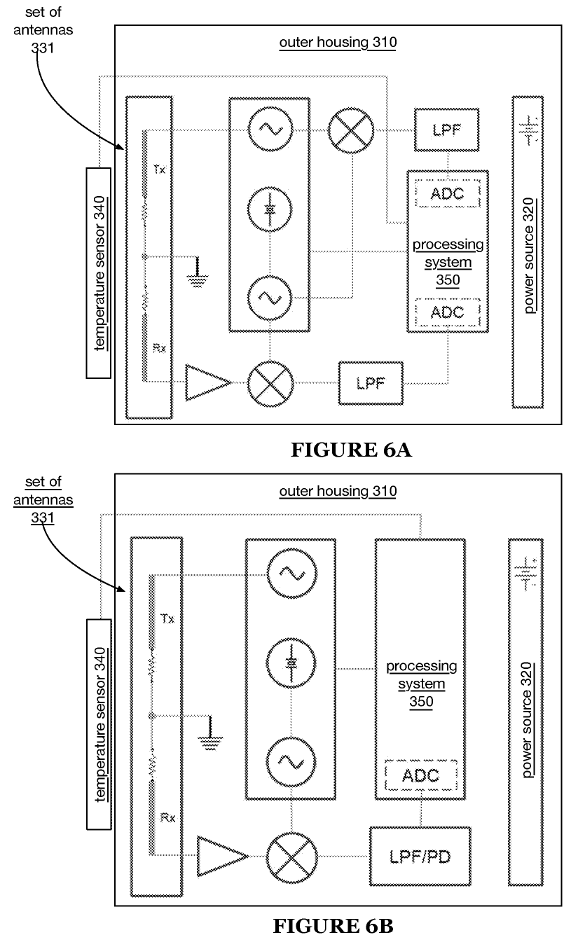

The reader circuit 360 can include the power source, the processing system, and/or any other components. Examples are shown in FIGS. 6A and 6B. In a first example, the circuit components can form a system which measures amplitude of the response signal (e.g., example shown in FIG. 6A). In a second example, the circuit components can form a system which measures both amplitude and phase of the response signal (e.g., example shown in FIG. 6B).

The components of the reader circuit can include a transmission coil, a receiver coil, a Wheatstone bridge (e.g., for impedance detection), a mixer and amplifier (e.g., that amplifies and mixes the received signal with the transmitted signal or reference oscillator; to demodulate the sensor's resonant response), a signal processing subcircuit (e.g., low-pass filter, peak detector, etc.), an ADC (e.g., to digitize the signal for the processing system), and/or any other components. The amplifier can be a low noise amplifier configured to amplify the set of response signals. In a first example, the reader circuit 360 can include circuit components that form a system which measures amplitude of the response signal. In a second example, the reader circuit components can form a system which measures both amplitude and phase of the response signal.

However, the reader circuit 360 may be otherwise configured.

Furthermore, the reader system may be otherwise configured.

### 3.5 System – Additional Elements

In variants, the system can additionally include a communication system that functions to communicate wheel end information (e.g., oil parameters, inflator parameters, tire parameters, wheel parameters, etc.) determined by the sensor, reader, inflator, and/or other component with a remote computing system. The communication system can be wired (e.g., CAN, Ethernet, etc.), wireless (e.g., cellular, ZigBee, Bluetooth, etc.) and/or otherwise configured. The remote computing system can be a gateway (e.g., in the vehicle, in the cab, offboard the vehicle, etc.), a cloud computing system, a user device (e.g., laptop, phone, etc.), and/or any other suitable computing system. The communication system can be located in: the sensor assembly, the hub cap, the reader system, the inflator, and/or in any other component.

However, the system can optionally include other suitable elements.

### 4. Method

Variants of the method can include: transmitting an excitation signal S100; receiving a response signal S200; and determining a set of hub oil parameters S300. The method functions to estimate hub oil parameters in a hub cap (e.g., example shown in FIG. 2). The method functions to estimate hub oil parameters in a hub cap (e.g., embodiment shown in FIG. 2). In more detail, the method can include: positioning a passive sensing element within an oil reservoir of a hub cap; positioning an inductive coil in proximity to the passive sensing element, wherein the inductive coil and passive sensing element cooperatively form an LRC circuit; generating a set of response signals upon exciting the LRC circuit with a reader; and with the reader, determining an oil temperature and an oil level from the set of response signals.

The method can be performed while a vehicle is stationary, while a vehicle is moving (e.g., while a wheel on which the components of the system are mounted is spinning, etc.), and/or at any other suitable time. The method can be triggered when a vehicle stops moving, when a vehicle is slowing down, when a vehicle has been stopped for a threshold amount of time, when a vehicle starts moving, when a vehicle exceeds a threshold speed, and/or any other vehicle condition.

The method is preferably performed using the system described above, but can additionally and/or alternatively be performed using any other suitable system.

In more detail, the method is preferably performed by the processing system controlling and/or receiving measurements from the set of capacitor electrodes, inductor, set of antennas and/or any other suitable system components, but can alternatively be performed by any other suitable system. The resultant hub oil parameters can be stored locally (e.g., at the wheel end), transmitted to a remote computing system (e.g., phone, gateway, cloud, etc.) via a communication system (e.g., NFC, Bluetooth, cellular, etc.), used to generate a user notification, and/or otherwise used.

In relation to system components described in Section 3 above, embodiments of a passive sensing element can include a set of capacitive plates. In an example, the capacitive plates can include Class 2 ceramic capacitors. In another example, the passive sensing element of Step S100 can include a resistive sensor. In relation to the LRC circuit described, in a variant, the passive sensing element can be arranged at least partially external to the oil reservoir.

### 4.1 Method – Transmitting Excitation Signals

Transmitting an excitation signal S100 functions to generate an excitation signal which induces an electric field across the set of capacitor electrodes. Transmitting an excitation signal S100 can be performed iteratively, at a predetermined timestep (e.g., every 15 minutes, etc.), after a predetermined amount of time since the vehicle has stopped has passed, and/or any other timing. As such, transmitting an excitation signal S100 can be performed at a set frequency, and/or in response to a triggering event (e.g., an event related to vehicle operation).

Transmitting an excitation signal S100 is preferably performed by the reader system, but can alternatively be performed by any other system. In examples, the excitation signal can excite at a single frequency, use a continuous frequency sweep, a step frequency sweep, white noise excitation, a chirp signal (e.g., a continuous frequency ramp), a multi-tone signal, etc.), and/or use any other set of signals.

Transmitting an excitation signal S100 can include a frequency sweep that can include sweep parameters to optimize performance (e.g., resolution, duration, power, etc.).

Transmitting an excitation signal S100 can be dynamically-determined (e.g., based on a previous measurement cycle), but can alternatively be predetermined (e.g., to search within a predetermined frequency range). (e.g., based on a previous measurement cycle), or predetermined (e.g., to search within a predetermined frequency range). S100 can have a frequency range between 40-MHz to an upper frequency threshold, 42-60Mhz, below 40-MHz, above 60 MHz, and/or any other suitable frequency range.

In relation to system components described in Section 3 above, S100 can cooperatively be performed by positioning a passive sensing element within an oil reservoir of a hub cap and positioning an inductive coil in proximity to the passive sensing element, wherein the inductive coil and passive sensing element cooperatively form an LRC circuit, where the LRC circuit is involved in signal transmission and/or signal reception, and where the inductive coil is structured to change inductance depending on oil level.

In one implementation of Step S100, exciting the LRC circuit can include applying a first frequency sweep, wherein determining an oil temperature (described in more detail below in relation to Step S300) can include measuring a first resonant frequency of the LRC circuit using the reader.

In another implementation of Step S100 (which is not mutually exclusive with the prior-described implementation), exciting the LRC circuit can include applying a second frequency sweep, wherein determining the oil level (described in more detail below in relation to Step S300) can include measuring a second resonant frequency of the LRC circuit using the reader.

In another implementation of Step S100 (which is not mutually exclusive with the prior-described implementations ) exciting the LRC circuit can include applying a frequency sweep, wherein determining the oil temperature (described in more detail below in relation to Step S300) can include measuring a first resonant frequency, and wherein determining the oil level comprises measuring a second resonant frequency.

However, transmitting an excitation signal S100 may be otherwise performed.

### 4.2 Method – Receiving Response Signals

Receiving a response signal S200 functions to receive data from which hub oil parameters can be determined.

Receiving a response signal S200 is preferably performed by a subset of the set of antennas (e.g., a set of receiver antennas, etc.), of the reader system and/or any other antennas. As such, S200 can include generating a set of response signals upon exciting the LRC circuit with a reader.

S200 is preferably performed during S100 (e.g., performed synchronously), but can alternatively be performed at another time. Receiving a response signal S200 is preferably triggered when S100 is performed, but can additionally and/or alternatively be triggered by the same trigger (e.g., related to vehicle operation, such as a stopped state or a stopping vehicle state, etc.), or alternatively by another suitable trigger.

The response signal is preferably generated by the sensor assembly, more preferably by the sensing element within the hub cap, but can additionally or alternatively be generated by any other component.

Receiving a response signal S200 can include a response signal that is preferably indicative of the voltage induced between the set of capacitive plates by the excitation signal, but can additionally or alternatively be indicative of the resistivity of the oil, and/or any other properties.

Receiving a response signal S200 preferably includes a rotation-agnostic response signal (e.g., doesn't change based on a rotation angle of the wheel due to the rotational symmetry of the set of capacitor electrodes, etc.), but can alternatively include a rotation dependent response signal.

The response signal can include: voltage, current, phase shift, amplitude attenuation, and/or any other sensing element response.

However, receiving a response signal S200 may be otherwise performed.

### 4.3 Method – Determine Oil Characteristic Parameters

Determining a set of hub oil parameters S300 functions to estimate information about the hub oil within the hub cap based on the response signal. Determining a set of hub oil parameters S300 is preferably performed after S200, but can alternatively be performed at another suitable time. Determining a set of hub oil parameters S300 is preferably performed by the processing system, but can alternatively be performed by another suitable system.

In variants, determining a set of hub oil parameters S300 includes an optional determining a set of intermediate variables S310; and extracting the set of hub oil parameters S320. As such, the method can optionally include determining a set of intermediate variables S310, which functions to determine a set of intermediate curves and/or intermediate parameters relating the excitation signal to the response signal.

Determining a set of intermediate variables S310 can include intermediate variables that can include curves and/or parameters representing attributes of the response signal and/or any other suitable system parameters. Determining a set of intermediate variables S310 can include variants wherein intermediate variables can be used to calculate oil hub parameters and/or can be used as oil hub parameters.

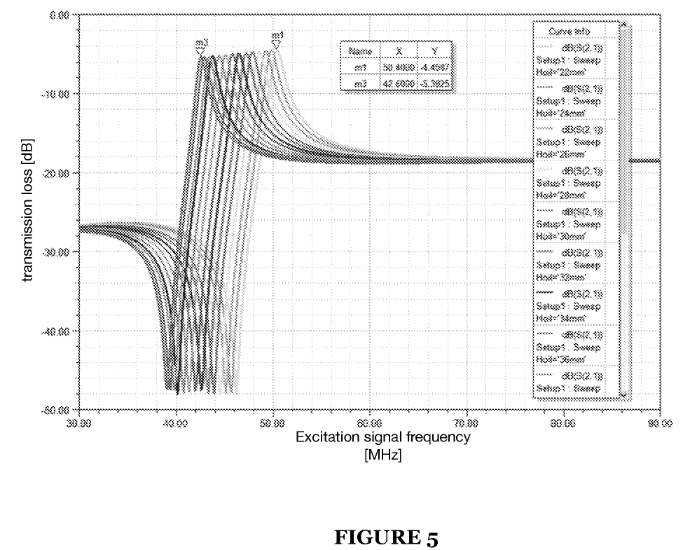

Examples of intermediate curves can include an excitation signal versus transmission loss curve, a phase vs frequency curve, an oscillation decay curve, and/or any other curves (e.g., an example shown in FIG. 5).

In an example, determining a set of intermediate variables S310 can include a transmission loss curve that can measure a relationship between frequency of the excitation signal and transmission loss (e.g., measured in dB, etc.).

Determining a set of intermediate variables S310 can include intermediate variables that can be determined directly from the response signal, additionally and/or alternatively from an intermediate curve (e.g., an excitation frequency can correspond to the peak of a transmission loss curve) and/or any other intermediate parameters.

However, the determining a set of intermediate variables S310 may be otherwise configured.

Extracting the set of hub oil parameters S320 functions to determine hub oil parameters from the response signal and/or the set of intermediate variables. Extracting the set of hub oil parameters S320 can extract hub oil parameters from the response signal directly (e.g., phase shifts, etc.), from intermediate curves determined from the response signal (e.g., resonant frequency, etc.), from temporal parameters determined from the response signal (e.g., resonant frequency decay, etc.), and/or from any other suitable information.

In variants, an intermediate variable can include a real or complex dielectric constant ε* (alternatively referred to as complex permittivity) from the combined amplitude and/or phase measurements. In such variants, the dielectric constant can be used for determining moisture parameters in S320. In this variant, the complex dielectric constant can provide a real component (related to energy storage) and/or an imaginary component (related to energy loss) of the dielectric properties of the hub oil and/or wheel hub volume.

In a first variant, extracting the set of hub oil parameters S320 can include determining the oil level. In this variant, extracting the set of hub oil parameters S320 can estimate the oil level from an intermediate curve determined in S310 (e.g., the transmission loss curve and/or any other curves). In this variant, the oil level can be determined by sweeping through a set of excitation frequencies, sampling the response signal at each excitation frequency, identifying the resonant frequency as the excitation frequency with the highest response signal (e.g., local maxima, maximum amplitude, etc.), and determining an oil level based on the resonant frequency.

In a first example, extracting the set of hub oil parameters S320 can include directly mapping the resonant frequency to an oil level using a lookup table, function, and/or any other suitable calculation.

In a second example, extracting the set of hub oil parameters S320 can include comparing the resonant frequency with resonant frequency at a baseline oil state (e.g., a measurement of an empty hub cap, a measurement of a full hub cap, a measurement of a newly-filled hub cap, etc.), and the difference in resonant frequencies can be mapped to a change in the oil level. However, the oil level can be otherwise determined.

In a second variant, extracting the set of hub oil parameters S320 can include determining an oil temperature. Determining an oil temperature can be based on the capacitance and resultant resonance frequency between the temperature-sensitive capacitors, described in relation to the system components of Section 3 above. The oil temperature can additionally or alternatively be determined by the temperature sensor or another suitable component. However, temperature can be otherwise measured and/or estimated.

In a third variant, extracting the set of hub oil parameters S320 can include determining an oil quality parameter.

In a first example of the third variant, extracting the set of hub oil parameters S320 can estimate an oil quality parameter Q (e.g., representing oil contamination, and/or any other contamination) from the shape of an intermediate curve (e.g., the transmission loss curve, and/or any other curve) and/or from a phase shift between the excitation signal and response signal. In a specific example of this variant, the bandwidth of frequencies resulting in transmission loss values within a predetermined decibel range (e.g., 3dB) of the peak can be mapped to an oil quality parameter Q. In a second specific example of this variant, the amplitude of the transmission loss curve can map to oil quality and/or water content.

In a second example of the third variant, extracting the set of hub oil parameters S320 can involve estimating changes in a dielectric constant (e.g., a complex dielectric constant, a real dielectric constant, etc.) of the oil (e.g., how much the oil affects electric field strength) from the changes in the resonant frequency. In this example, when tracked over time, such changes can indicate a contamination type (e.g., gradual changes indicating water entering the hub cap slowly over time vs a sudden changes indicating a system component fragment breaking off and suddenly entering the hub cap).

In a third example of the third variant, extracting the set of hub oil parameters S320 can estimate oil viscosity from a temporal function of any suitable measured value (e.g., based on a decay of the measured value as oil settles within the hub cap). In a specific example, after the vehicle stops moving, extracting the set of hub oil parameters S320 can include the reader system transmitting an excitation signal in order to determine how quickly the oil settles which gives information on the oil viscosity.

However, oil quality, viscosity, and/or other aspects can be otherwise determined.

In a fourth variant, moisture parameters (e.g., water content) of the oil and/or hub volume can be estimated from a complex dielectric constant (e.g., determined in S310). In this example, the imaginary component can be used to estimate moisture content, water vapor presence, humidity levels in the oil, and/or any other suitable moisture parameters.

In a fifth variant, extracting the set of hub oil parameters S320 can be for determining long-term oil quality. Extracting the set of hub oil parameters S320 can determine oil quality parameters over time and store them for analysis. Extracting the set of hub oil parameters S320 can track parameters such as viscosity, water content, and debris content and/or debris accumulation which can change as the oil degrades. Extracting the set of hub oil parameters S320 can include setting a baseline when the oil is new and measuring deviations from this baseline over time.

The aforementioned variants and/or examples related to S320 are not mutually exclusive with one another. In any of the aforementioned variants, S320 can include using measured temperature (e.g., by the temperature sensor) to compensate for any thermal effects impacting measured and/or estimated values, and/or otherwise used.

However, extracting the set of hub oil parameters S320 may be otherwise performed.

Furthermore, determining a set of hub oil parameters S300 may be otherwise performed.

### 5. Conclusions

Although omitted for conciseness, the preferred embodiments include every combination and permutation of the various system components and the various method processes, wherein the method processes can be performed in any suitable order, sequentially or concurrently.

All references cited herein are incorporated by reference in their entirety, except to the extent that the incorporated material is inconsistent with the express disclosure herein, in which case the language in this disclosure controls.

As used herein, "substantially" or other words of approximation can be within a predetermined error threshold or tolerance of a metric, component, or other reference, and/or be otherwise interpreted.

Optional elements, which can be included in some variants but not others, are indicated in broken lines in the figures.

Different subsystems and/or modules discussed above can be operated and controlled by the same or different entities. In the latter variants, different subsystems can communicate via: APIs (e.g., using API requests and responses, API keys, etc.), requests, and/or other communication channels. Communications between systems can be encrypted (e.g., using symmetric or asymmetric keys), signed, and/or otherwise authenticated or authorized.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

Additional or alternative embodiments implement the above methods and/or processing modules in non-transitory computer-readable media, storing computer-readable instructions. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

As a person skilled in the art will recognize from the previous detailed description and from the figures and claims, modifications and changes can be made to the preferred embodiments of the invention without departing from the scope of this invention defined in the following claims.

We claim:

1. A method comprising:
° positioning a passive sensing element within an oil reservoir of a hub cap;
° positioning an inductive coil in proximity to the passive sensing element, wherein the inductive coil and passive sensing element cooperatively form an LRC circuit;
° generating a set of response signals upon exciting the LRC circuit with a reader; and
° with the reader, determining an oil temperature and an oil level from the set of response signals.

2. The method of claim 1, wherein the passive sensing element comprises a set of capacitive plates.

3. The method of claim 2, wherein the set of capacitive plates comprise Class 2 ceramic capacitors.

4. The method of claim 1, wherein the passive sensing element comprises a resistive sensor.

5. The method of claim 1, wherein the passive sensing element is arranged at least partially external to the oil reservoir.

6. The method of claim 1, wherein exciting the LRC circuit comprises applying a first frequency sweep, and wherein determining an oil temperature comprises measuring a first resonant frequency of the LRC circuit using the reader.

7. The method of claim 6, wherein exciting the LRC circuit comprises applying a second frequency sweep, and wherein determining the oil level comprises measuring a second resonant frequency of the LRC circuit using the reader.

8. The method of claim 1, wherein exciting the LRC circuit comprises applying a frequency sweep, wherein determining the oil temperature comprises measuring a first resonant frequency, and wherein determining the oil level comprises measuring a second resonant frequency.

9. The method of claim 1, wherein the reader comprises a low noise amplifier configured to amplify the set of response signals.

10. The method of claim 1, further comprising determining oil viscosity, water content, and debris accumulation using the set of response signals.

11. A system comprising:
° a hub cap defining an oil reservoir;
° an LRC circuit positioned at least partially external to the oil reservoir, wherein the LRC circuit is in communication with the passive sensor assembly and configured to convert a signal from the passive sensor assembly to a resonant frequency; and
° a reader in communication with the LRC circuit, wherein the reader comprises:
o an excitation subsystem configured to generate a set of response signals upon exciting the LRC circuit with a frequency sweep; and
o a processing system configured to convert the set of response signals to an oil temperature value and oil level value.

12. The system of claim 11, wherein the passive sensing element comprises a pair of capacitive plates.

13. The system of claim 12, wherein a dielectric layer disposed between the pair of capacitive plates comprises temperature sensitive material.

14. The system of claim 12, further comprising a spacer positioned between the pair of capacitive plates, wherein the spacer maintains substantially parallel spacing between the capacitive plates.

15. The system of claim 11, wherein the passive sensing element comprises an inductive coil configured to change capacitance depending on oil level.

16. The system of claim 11, wherein the passive sensing element is positioned with clearance from an interior wall of the hub cap configured to prevent electrical shorting from conductive debris within the oil reservoir.

17. The system of claim 11, wherein the reader is integrated into a housing of the hub cap.

18. The system of claim 11, wherein the reader further comprises a standalone module that is removably coupled with the hub cap.

19. The system of claim 11, wherein the reader further comprises a first antenna configured to excite the LRC circuit, and a second antenna configured to receive the set of response signals.

20. The system of claim 11, further comprising a magnetic fill plug positioned within the oil reservoir and positioned to attract and collect metallic debris present in the oil, wherein the magnetic fill plug is positioned with clearance from the passive sensor assembly.
